(19) United States
(12) Patent Application Publication
(10) Pub. No.: US 2005/0257093 A1
(43) Pub. Date: Nov. 17, 2005

(54) Dynamic update of pluggable modules using a reference manager

(76) Inventors: Stephen L. Johnson, Erdenheim, PA (US); Jinhong Katherine Guo, West Windsor, NJ (US); Il-Pyung Park, Princeton Junction, NJ (US)

Correspondence Address: HARNESS, DICKEY & PIERCE, P.L.C., P.O. BOX 828, BLOOMFIELD HILLS, MI, 48303, US

(21) Appl. No.: 10/829,096

(22) Filed: Apr. 21, 2004

(51) Int. Cl. G06F 11/00

(52) U.S. Cl. 714/38

(57) ABSTRACT

A method is provided for replacing a loadable software module in an operating system. The method include: maintaining a reference count for a loadable software module associated with a kernel of the operating system; linking a replacement software module for the loadable software module into the kernel of the operating system; receiving a resource request for the loadable software module after the replacement software module is linked into the kernel; and directing the resource request for the loadable software module to the replacement software module. The method may further include unlinking the loadable software module from the kernel of the operating system when there are no longer any active references to the loadable module.

### FIELD OF THE INVENTION

The present invention relates to loadable kernel modules and, more particularly, to a method for dynamically replacing a loadable software module using a reference count manager.

### BACKGROUND OF THE INVENTION

Certain operating systems allow loadable software modules to be part of the kernel. For example, loadable kernel modules are supported by the Linux kernel. In some instances, the software modules can be loaded or linked into the kernel dynamically. Likewise, such software modules can be unloaded or unlinked from the kernel when needed. To replace a loaded software module, the loaded software module is typically unloaded before a replacement module is loaded into the execution environment. This approach may cause instability in the operating system if some process is currently using the loaded software module. For certain critical system operations, such as kernel security modules, this conventional approach is unacceptable.

Therefore, it is desirable to provide a mechanism for dynamically replacing a loadable software module without first removing the module from the execution environment.

### SUMMARY OF THE INVENTION

In accordance with the present invention, a method is provided for replacing a loadable software module in an operating system. The method include: maintaining a reference count for a loadable software module associated with a kernel of the operating system; linking a replacement software module for the loadable software module into the kernel of the operating system; receiving a resource request for the loadable software module after the replacement software module is linked into the kernel; and directing the resource request for the loadable software module to the replacement software module. The method may further include unlinking the loadable software module from the kernel of the operating system when there are no longer any active references to the loadable module.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

FIG. 1 is a flowchart depicting a software-implemented method for replacing a loadable software module in accordance with the present invention; and

2A-2E are block diagrams illustrating the interaction amongst software components residing in an exemplary execution environment in accordance with the present invention.

### DETAILED DESCRIPTION OF THE PREFERRED EMBODIMENTS

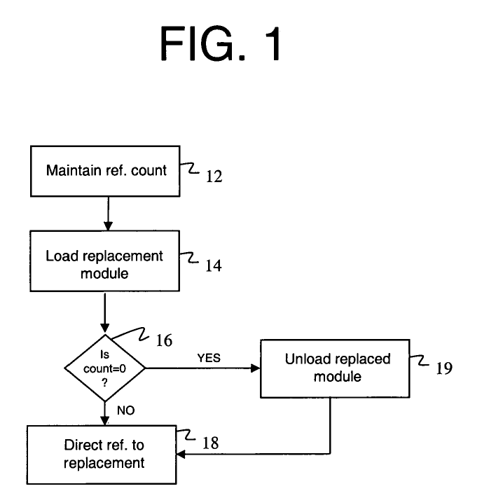

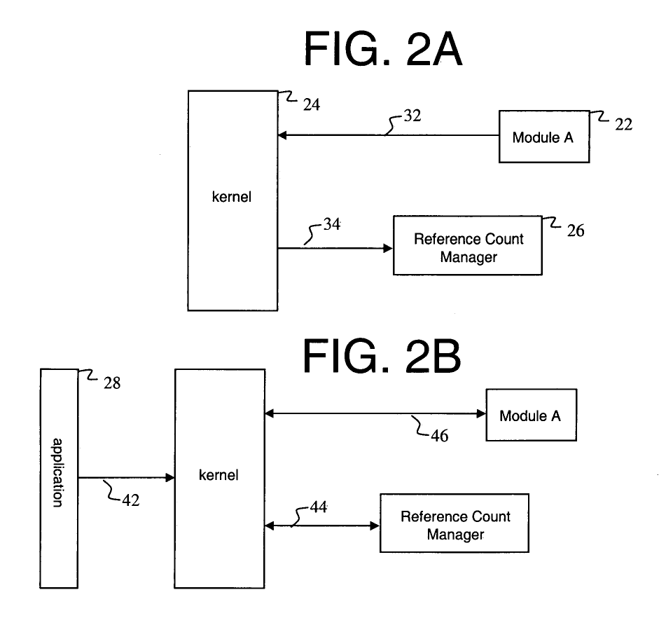

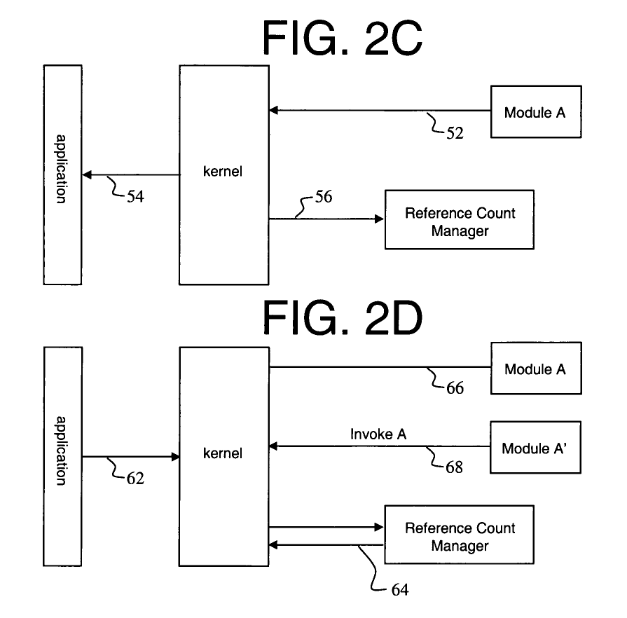

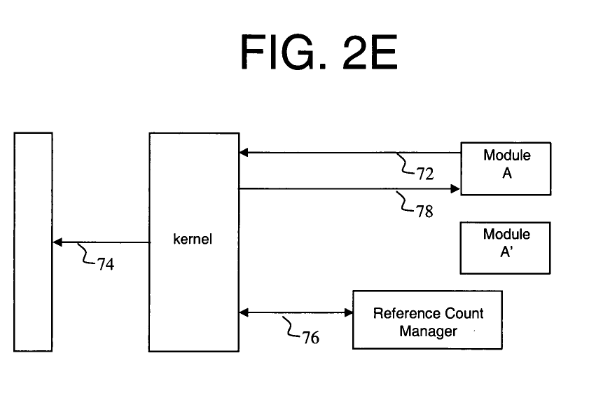

Referring to FIG. 1, a software-implemented method is provided for replacing a loadable software module in accordance with the present invention. In an exemplary embodiment, the loadable software module is linked into the Linux kernel which forms the basis of an execution environment of a computing device. While the following description is provided with reference to the Linux kernel, it is readily understood that the present invention is generally applicable for replacing loadable software modules associated with other types of kernels and/or operating systems.

To ensure operating system stability, a reference count manager is employed to keep track of how many active references there are to the loadable software module. The reference count manager maintains a counter at step 12 that is incremented whenever a new reference occurs and is decremented whenever the reference is complete. A reference generally refers to a resource request of the loadable software module. In the context of the Linux kernel, a reference refers to a sequence of instructions executed by the kernel to handle a system call, an exception, or an interrupt.

The dynamic replacement of software modules proceeds as follows. First, a replacement software module for the loadable software module is loaded at step 14 into the operating system. Upon receipt of a new reference for the loadable software module, the reference count manager then evaluates the reference count for the loadable software module as shown at step 16.

If the reference count for the loadable software module is zero, then the loadable software module may be unloaded or otherwise discarded at step 19 by the operating system. Thus, the new reference is handled by the remaining replacement software module.

On the other hand, if the reference count for the loadable software module is not zero, then the loadable software module is maintained until all existing references to it have been resolved. In this case, any new references are directed at step 18 to the replacement software module. As soon as the count for the loadable software module reaches zero, the loadable software module is unloaded from the operating system.

A more detailed description of the replacement technique of the present invention is set forth in relation to FIGS. 2A-2E. In FIG. 2A, a new software module 22 is being loaded into the execution environment. The software module first registers with the kernel 24 as diagrammatically shown at 32. Registered information includes module name, version number and other identifying information as well known in the art. In the context of the Linux kernel, the new software module 22 may be linked into the running kernel by executing the insmod utility program.

The kernel in turn sends a request to the reference count manager 26 at 34 to set up a counter for the new software module 22. It is readily understood that the request identifies the module name, version number and other identifying information for the software module 22. As noted above, the reference count manager 26 maintains a count for each loadable module as well as for each version of a loadable module. If the new software module 22 does not have a corresponding older version, the reference count manager 26 establishes the only counter for the module; otherwise, the reference count manager 26 creates an additional counter for this newer version of the module.

An application 28 may then initiate a resource request for the software module 22 as shown at 42 of FIG. 2B. For instance, the application 28 may request a function provided by the software module 22. The resource request is received by the kernel 24 which in turn evaluates the reference count at 44 maintained by the reference count manager 26. To do so, the kernel 24 sends a request at 46 to the reference count manager 26. The request to the kernel identifies the module name, version number and other identifying information for the software module 22 as provided by the application 28. In response to the request, the reference count manager 26 increments the reference count for the software module 22. In addition, the reference count manager 26 communicates the counter status for each version of the software module 22 back to the kernel 24. Since there is only a single version of the software module 22, the kernel 24 invokes the requested function at 46 in a conventional manner.

After the requested function is completed, the software module 22 sends the kernel notification as shown at 52 of FIG. 2C. The kernel 24 in turn passes the result at 54 to the application 28. The kernel 24 also sends a request at 56 to the reference count manager 26. Again, the request to the kernel 24 identifies the module name, version number and other identifying information for the software module 22. In response to the request, the reference count manager 26 decrements the reference count for the software module 22.

In FIG. 2D, a replacement module 29 for the software module 22 has also been loaded into the execution environment. In an exemplary scenario, the application 28 may initiate an additional resource request for the software module as shown at 62. The kernel 24 in turn evaluates the reference counts for the requested software module at 64 as maintained by the reference count manager 26. For illustration purposes, the reference count for the software module 22 is one; whereas the reference count for the replacement module 29 is zero. This reference to the software module 22 is diagrammatically shown at 66.

The reference count manager 26 first communicates the counter status for each version back to the kernel 24. The reference count manager 26 also increments the reference count for the replacement module 29 to one in response to the resource request from application 28. Lastly, the kernel 24 directs the request at 68 to the most recent version; i.e., replacement module 29. Thus, the kernel 24 invokes the requested function from the replacement module 29 in a conventional manner. Subsequent resource requests for the software module are handled in a similar manner up until all of the references for the replaced software module 22 are complete.

Upon completion of the last reference to the replaced software module 22, processing proceeds as shown in FIG. 2E. First, the replaced software module 22 notifies the kernel 24 at 72. The kernel 24 in turn passes the result at 74 to the requesting application 28. The kernel 24 also passes notification of this event at 76 to the reference count manager 26. The reference count manager 26 decrements the reference count for the replaced software module 22 and then communicates counter status for each version of the module back to the kernel 24. In this example, the reference count for the replaced software module 22 is zero.

The kernel 24 can be safely unloaded or otherwise discard the software module from the operating system as shown at 78. In the context of the Linux kernel, the replaced software module 22 may be unlinked from the running kernel by executing the rmmod utility program. Any subsequent references to the module are handled seamlessly by the replacement module 29. In this way, the technique of the present invention dynamically replaces a loadable software module within the kernel without first removing the module from the execution environment, thereby maintaining the stability of the operating system.

It is readily understood that only the relevant steps of the methodology are discussed above, but that other software-implemented instructions may be needed to maintain the overall operation of the kernel. It is also understood that portions of the kernel and/or operating system may need to be modified to support the present invention, but that such modifications are readily understood from the descriptions provided above.

Lastly, this methodology may be suitable used to replace loadable software modules in other known kernels or operating systems. However, one particular application is for replacing access control modules or other security related modules supported within the Linux Security Module framework. In addition, it is envisioned that this methodology may also be extended to the replacement of other resources within the context of the operating system. For instance, there may be look-up tables, security policies or other replaceable resources which are being accessed within the operating system. In these instances, it is envisioned that such resources may be dynamically replaced using the technique of the present invention without first removing the resource from the execution environment. Thus, the description of the invention is merely exemplary in nature and, thus, variations that do not depart from the gist of the invention are intended to be within the scope of the invention. Such variations are not to be regarded as a departure from the spirit and scope of the invention.

1. A software-implemented method for replacing a loadable software module in an operating system, comprising:
maintaining a reference count for a given software module loaded in the operating system;
loading a replacement software module for the given software module into the operating system;
receiving a reference for the given software module after the replacement software module is loaded into the operating system; and
directing the reference for the given software module to the replacement software module when the reference count is greater than zero.

2. The method of claim 1 further comprises maintaining a reference count for the replacement software module.

3. The method of claim 1 wherein the step of directing the reference to the replacement software module further comprises incrementing a reference count for the replacement software module.

4. The method of claim 1 further comprises unloading the given software module when the reference count is zero.

5. The method of claim 1 wherein the step of maintaining a reference count further comprises incrementing the reference count when an application invokes a requested function provided by the given software module and decrementing the reference count when the requested function is completed by the given software module.

6. The method of claim 1 wherein a reference is further defined as a requested function provided by the given software module.

7. The method of claim 1 wherein the step of maintaining a reference count is performed by a reference count manager.

8. A software-implemented method for replacing a loadable software module in an operating system, comprising:
maintaining a reference count for a loadable software module associated with a kernel of the operating system;
linking a replacement software module for the loadable software module into the kernel of the operating system;
receiving a resource request for the loadable software module after the replacement software module is linked into the kernel;
directing the resource request for the loadable software module to the replacement software module when the reference count is greater than zero; and
unlinking the loadable software module from the kernel of the operating system when the reference count is zero.

9. The method of claim 8 maintaining a reference count for the replacement software module.

10. The method of claim 8 wherein the step of directing the reference to the replacement software module further comprises incrementing a reference count for the replacement software module.

11. The method of claim 8 wherein the step of maintaining a reference count further comprises incrementing the reference count when a kernel control path starts using the loadable software module and decrementing the reference count when the kernel control path stops using the loadable software module.

12. The method of claim 8 wherein the kernel of the operating system is further defined as a Linux kernel.

13. The method of claim 12 wherein the loadable software module is further defined as an access control module operating within the Linux Security Module framework.

14. A software-implemented system for coordinating replacement of a loadable software module residing in an execution environment, comprising:
a reference count manager residing in the execution environment and operable to maintain a reference count for the loadable software module; and
a kernel residing in the execution environment and operable to load a replacement software module into the execution environment, the kernel adapted to receive a resource request for the loadable software module after the replacement software module is loaded and operable to direct the resource request to the replacement software module when the reference count is greater than zero.

15. The computer-implemented system of claim 14 wherein the reference count manager is operable to maintain a reference count for the replacement software module.

16. The computer-implemented system of claim 14 wherein the kernel is in data communication with the reference count manager to access the reference count upon receipt of the resource request for the loadable software module.

17. The computer-implemented system of claim 14 wherein the kernel is further operable to unload the loadable software module when the reference count is zero.

18. The computer-implemented system of claim 14 wherein the reference count manager increments the reference count when a kernel control path starts using the loadable software module and decrements the reference count when the kernel control path stops using the loadable software module

19. The computer-implemented system of claim 14 wherein the kernel of the operating system is further defined as a Linux kernel.

20. The computer-implemented system of claim 14 wherein the loadable software module is further defined as an access control module operating within the Linux Security Module framework.
